(19) United States
(12) Patent Application Publication
(10) Pub. No.: US 2018/0052867 A1
(43) Pub. Date: Feb. 22, 2018

(54) Computer System for Storing and Managing Digital Assets Using Virtual Repositories for Flexible Redirection of References

(71) Applicant: Tippett Studio, Berkeley, CA (US)

(72) Inventor: Alex D. Seiden, Berkeley, CA (US)

(21) Appl. No.: 15/239,667

(22) Filed: Aug. 17, 2016

(51) Int. Cl. G06F 17/30

(52) U.S. Cl. CPC G06F 17/30233

(57) ABSTRACT

A digital asset management system performs path translations for files referenced using virtual file system pathnames translated to physical file system pathnames by intercepting an original file access request from an application, resolving to a physical pathname, passing a modified file access request to an operating system that corresponds to the original file access request with the physical pathname in place of the virtual pathname, receiving a response from the operating system, the response being to the modified file access system, and passing the response to the application that made the original file access request. Mapping from an original file access request from a virtual pathname to a physical pathname can be performed using a path resolution engine, using one or more view datasets, that can serve different file access requests using different views. View datasets can be independent of the virtual file system pathnames used.

### FIELD OF THE INVENTION

The present disclosure generally relates to managing files and other digital assets. The disclosure relates more particularly to apparatus and techniques for storing, managing, controlling access to and organizing digital assets as might be used in a complex project involving large numbers of files and other digital assets.

### BACKGROUND

In large complex computing projects involving many people and a large number of files or other digital assets, storing, managing, controlling access to and organizing these digital assets can be difficult. Some examples of such computing projects include computer animation projects, visual effects development, computer game development, virtual reality programs, web development, and other fields where computer files might contain references to other computer files.

As used herein, a “file” refers to data stored as an addressable unit for operations known as file operations. In some operating systems and computer systems, digital assets not traditionally referred to as files are treated as files. For readability, in the examples provided herein, various different digital assets, traditionally thought of as files or otherwise, are referred to herein as files. A directory, also called a folder, is a data structure for organizing or locating zero or more files. An asset, as used in the examples herein, can refer to a file, a set of multiple files, a directory, or a set of multiple directories, interchangeably unless otherwise indicated.

A filesystem is a physical or virtual storage device, such as a computer hard disk, that can store multiple assets. A filesystem is called a “network file system” when it is usable by many computers on a network. A file pathname is a representation of the location of a file or directory or other asset on a filesystem. In some filesystems, a pathname is a specification of a “filepath” that defines a file's name and its location within directories and nested subdirectories.

Creating a computer-animated feature film is one example of a computing project that requires the use and management of a large number of digital assets. These assets can describe such things as a computer-generated character, a digital stage set, or the animation and compositing data for each of the shots from such projects.

Creating computer graphics involves using many different application software packages. Some of this software is programmed “in house,” by the studio creating the animation. Some of it is created by third party vendors. Often, several independent third-party vendors are used. Various “pipeline” tools are written to connect all of the tools so that artists are able to use them together.

One computer-animated feature film might comprise thousands of assets describe all the parts that go into creating the finished images, sounds, interactivity, etc. and the various versions of portions of the film. The creation of these files involves many iterations of improvement, as variations in artistic intent, and changes to the mode of representation. Any of these changes can create a new version of the file. It is generally desirable to maintain multiple versions of an asset. This serves as a means of protecting the production, in case a revision of an asset turns out worse than an earlier version for either technical or creative reasons.

For these and other reasons, assets can be expected to require references to other assets. One asset might have references to other assets hardcoded in, but then that is easily broken when assets are reorganized or moved.

What is needed is a flexible system for managing all of these assets without requiring intimate knowledge of file structures by the artists and other users of these assets, taking into account that not all tools that use those assets are able to handle redirection of references.

### SUMMARY

A digital asset management system comprises at least one computing device configured to implement one or more services, wherein the one or more services are configured to perform path translations, wherein files are referenced using virtual file system pathnames and a path translation translates a virtual file system pathname to a physical file system pathname, intercept an original file access request from an application, resolve a file pathname in the original file access request from a virtual pathname to a physical pathname, pass a modified file access request to an operating system, wherein the modified file access request corresponds to the original file access request with the physical pathname in place of the virtual pathname, receive a response from the operating system, the response being to the modified file access system, and pass the response to the application that made the original file access request.

The following detailed description together with the accompanying drawings will provide a better understanding of the nature and advantages of the present invention.

### BRIEF DESCRIPTION OF THE DRAWINGS

Various embodiments in accordance with the present disclosure will be described with reference to the drawings, in which:

FIG. 1 is a schematic drawing of a digital asset file containing references to other files.

FIG. 2 is an illustration of references to other files and user actions, operating system actions, and other actions involved in retrieving a referenced file.

FIG. 3 is a simplified schematic drawing of portions of a digital asset management system and how they might operate.

FIG. 4 is a simplified schematic of how an artist, using the digital asset management system, might select and use a specific view to access relevant content for a task.

FIG. 5 is a simplified schematic diagram of a how an artist, using the present the digital asset management system, could access a local “sandbox” copy of the asset's files.

FIG. 6 is a simplified listing of an asset file, as it might exist using prior art.

FIG. 7 is a simplified listing of an asset file, as it might exist using prior art.

FIG. 8 is a simplified listing of an asset file.

FIG. 9 is a simplified schematic diagram of nested references.

FIG. 10 illustrates aspects of a view resolution engine.

FIG. 11 illustrates an environment for various implementations.

FIG. 12 illustrates various structures that might be present in a computer memory in which various implementations can be implemented.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Techniques described and suggested herein include asset management. A digital asset management system as described herein can store and access digital asset files from a file repository using operating system modifications or extensions to intercept file operations from digital content creation software or other software, and retrieve and supply the data requested. This allows for redirecting embedded references within one file to other files in the repository. It allows the same filepath to be used in multiple contexts, such that it can be resolved to a user or algorithmically selected version of any digital asset. The disclosed system can resolve a fixed virtual filepath to the appropriate physical filepath.

While not intended to be limiting, many of the examples herein illustrate inventive concepts specifically in reference to a computer animation project, in which many different computer-generated image digital assets are assembled and processed to form an audiovisual presentation of some kind. As such, that might involve digital assets such as background images, textures, geometric models, sounds, articulated character rigs, choreography, movement schedules, lighting details, details about behaviors, etc. Some or all of these digital assets would be needed at one time. For example, to render and generate the entire audiovisual presentation, all of the most current versions of the digital assets might be used, whereas to gather artist input on animating a character in a particular scene, not all of the digital assets need be used.

A digital asset might refer to other digital assets. For example, a file representing a particular scene in a movie might refer to the files associated with each of the characters and other objects in the scene. A digital asset might be nothing more than a set of references to other digital assets, but also a file might have content itself and pointers or references to content in other files. As production proceeds, the correct references from one file to another must be maintained and updated appropriately. These references might be nested, with one file referencing several others, each of which references further files, and so on.

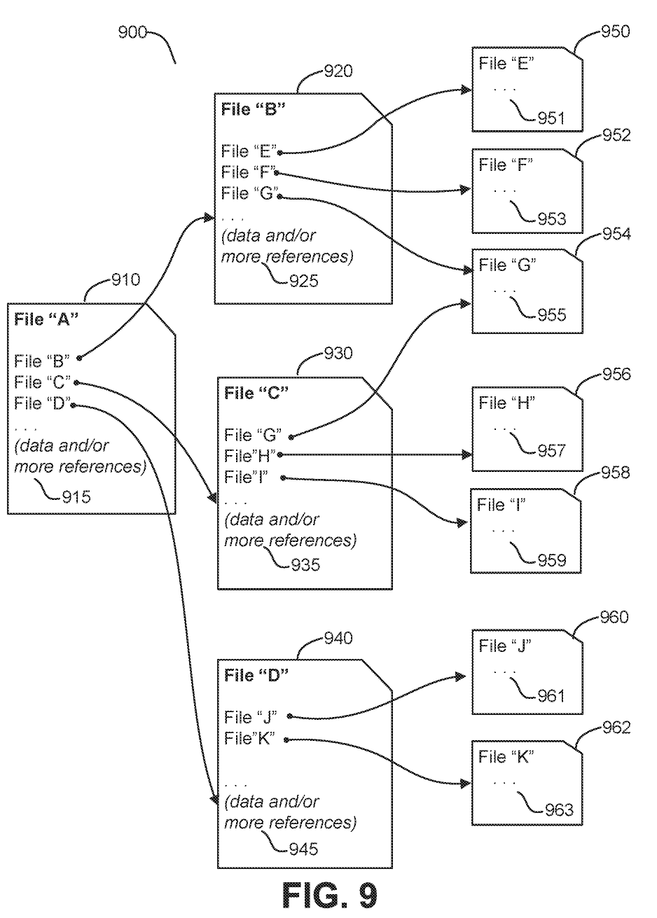

This is exemplified in FIG. 9, which illustrates how files can reference other files, and how assets can be formed through the logical aggregation of many files. In FIG. 9, file “A” 910 is the top node of an asset and contains references 915 to three other files, file “B” 920, file “C” 930, and file “D” 940, and possibly its own data and/or further references. In turn, file “B” 920 contains references 925 to three other files, file “E” 950, file “F” 952, and file “G” 954, and possibly its own data and/or further references. Similarly, file “C” 930 contains references 935 to three other files, file “G” 954, file “H” 956, and file “I” 958, and possibly its own data and/or further references. Note that in this case, both file “B” 930 and file “C” 930 have references to file “G” 954. This illustrates that one file can be referenced by one or more other files.

Logically, the graph of file references does not have to be a pure tree structure, but can be a directed acyclic graph (“DAG”) or similar structure. The data references 945 in file “D” 940 work in the same manner as the other files. Files “E” through “K” (950, 952, 954, 956, 958, 960, 962) also can all contain their own data and references (951, 953, 955, 957, 959, 961, 963), and the DAG can continue without any fixed limit.

Although the examples of FIG. 9 are all references to specific files, it should be understood that references could be to other digital assets such as directories or their contents. References could be to aggregate groups of files or directories. One manner of specifying references is using a regular expression, a string using wild card characters or other computer-parseable expressions or other algorithmic methods of specifying files implicitly.

Computer graphics is a collaborative medium and many artists may work together to make the final imagery. These artists have specialized skills and are usually separated into departments that focus on one task or skill set. For example, a “modeler” will create the geometry of a character, a “painter” will create the surface color and texture, and an “animator” will specify a character's movement. All of these artists need to work together, by sharing the computer files where their work is stored. The larger the project and the larger the studio, the more complex this sharing of assets becomes.

Generally, the artists in one department will edit a subset of the files that comprise an asset. For example, painters will change texture files, but not the geometry files. Modelers will change geometry files, but not the texture files or animation files. Some files may need to be created and/or edited by multiple departments. The various departments need methods of sharing these files with the rest of the studio. Artists need to be able to distinguish which file versions are ready for general use by the entire production, and which are still in the process of creation, and may require more work by downstream departments. Additional complexity arises when tools created by different software vendors are used. Yet additional complexity arises when a studio has multiple offices in different locations. Yet additional complexity arises when different companies are involved, and not just one studio is doing all the work.

As such, the management of digital asset files is a problem in computer graphics production. Many studios invest substantial internal resources in developing a “pipeline” that allows, among other things, selection of the technically compatible and artistically appropriate versions of files from the multitude of versions that have been authored. Both the technical and artistic needs change during the course of the production process, and may differ in different parts of the film. The complexity of this task, and the multitude of ways it may be solved, is evidenced by the many peer-reviewed papers at academic conferences that discuss various procedures and systems of asset management and access.

Artists need to be able to create, edit, share and publish files. An artist might share files with other artists while development on these files is still in progress and not ready to be published. When “published” files become accessible for larger groups of artists at the studio, including establishing the new version as a “default” or “approved” version that will be automatically accessed by subsequent uses of the files. Thus, an artist or others might need to access a history of the various versions of files, select particular versions of files from a multitude of different versions, such that the files are technically compatible, and express the appropriate artistic intent, and/or work in a manner that does not interfere with other users who may be simultaneously working with the prior versions of the asset.

Current methods of solving these problems rely on several solutions to store digital assets and determine which versions of a file are the correct ones to use. The correct version of a file to use will vary based on many criteria, such as what department the artist is working in, and what task they are performing; the current stage of the production; between various shots and sequences in the production, etc. Different studios have adopted one or more of the following techniques:

1. One method involves using textual search-and-replace to alter the contents of a digital content file. This has the limitation that the file must be stored in a common textural format that is readily editable, and whose syntax and semantics are documented. While undocumented file formats can be reverse-engineered, this requires a substantial amount of work, and may break at any time if the format changes. Binary files suffer from similar limitations.

2. Another method is to use “symbolic links” to create indirect references that are modified to select the desired version of any asset or component thereof. This has the limitation that software can detect that a symbolic link is being used, and some software packages will “dereference” the link, thereby defeating its ability to serve as a method of redirection. A further limitation is that attempting to write a file to a reference specified by a symbolic link will, in most cases, replace the symbolic link with the actual contents of the file, thereby destroying the abstraction layer that symbolic links provide. A further limitation of this method is that some operating systems do not support symbolic links.

3. Another method is to use “relative paths,” where the location of a file will be specified not by its “absolute” location on the file system, for example a filepath like “/shows/movieName/characters/characterName/geometry/characterName.abc”, but by a “relative path” such as “geometry/characterName.abc”, where the “current working directory” is “/shows/movieName/characters/characterName”. This has the limitation that different software packages use different means to determine their current working directory. For example, some packages will consider the current working directory to be the same as the shell from which the user launched the application; others will set the cwd to where the application's executable code is installed; others allow configuration of the cwd inside the package itself, or via an “environment variable” that's specified outside the package.

4. Another method is to use “search paths” where several possible locations for the desired asset are listed. Each location is checked for the existence of the referenced asset, and the first copy found is used. This has the limitation that many applications will not support search paths at all, or may have limitations or idiosyncrasies in their use. Such limitations include how a search path is specified, on what type of data can be searched for in such a manner, or may use different algorithms for resolving how the paths are searched.

5. Another method is to use the Application Programmer Interface (API) of vendor software, if one has been provided, to alter the file system locations to which external references point. This has the limitation that many software applications may not provide such an API, or it may be insufficient, limited, or difficult to use. Usually, this requires specialized “adaptor” development for each vendor software package, as well as maintenance of this adaptor code. Additionally, the requirement for this code means that new vendor packages cannot be as quickly integrated into the existing system or “pipeline” of a studio. In a fast moving industry where new tools are constantly being introduced, this is a significant limitation.

6. Some vendor software suites provide tools that allow bulk modification of asset references within their particular package, either by allowing the user to “search and replace” specific path components, or having the user create specific rules that rewrite the paths. However, each vendor package has different paradigms and methods of doing this, which may not be compatible with other vendor tools or studio authored software.

7. Another method is to abandon the use of compound assets entirely, and have all artists explicitly assemble the correct versions of each file that constitutes the asset. One disadvantage of this method is that it requires substantial efforts of all the artists involved, and offers many opportunities for error. Another disadvantage of this method is that embedded file references often cannot be avoided.

8. Another method is to use database software, such as a relational database like MySQL, or what is sometimes referred as a “schemaless” database such as MongoDB, to store the files or their components. A disadvantage of this method is that it generally requires specific engineering effort for each software application used by the studio in order to integrate this method into the overall studio pipeline, since most, if not all, vendor software, requires file data to be accessible via a filepath.

9. Another method utilizes traditional source code control systems (such as a Perforce™ system, a Subversion™ system, or an RCS system) to store files. While this can be a satisfactory method for maintaining a persistent historical record of the files that compose an asset, it generally provides no mechanism for handling embedded references from one file to another, and relies on the software applications to resolve these problems. This often equates to using some combination of the search paths techniques (method 4, above) and the relative path techniques (method 3).

All of these prior methods suffer from several flaws and limitations. These limitations are particularly apparent when all or some of the digital content creation software are tools that were created by an external software vendor, rather than being proprietary tools developed by the studio. Such software may or may not be amenable to end-user enhancements that would allow these prior methods to be implemented.

Methods that require alteration of filepaths as they are embedded within a file suffer from a further disadvantage, in that as soon as the textual alteration is made, a comparison of the files, either by algorithm or by user inspection, makes the files appear to be different, even where they refer to data that is identical to the data prior to textural substitution.

These problems are magnified when multiple software packages are combined, especially when using products made by several independent third-party vendors.

Software is constantly changing, with new and improved software products and paradigms frequently released. All of these prior methods require the studio to individually engineer a solution for each content creation application. This makes it difficult for a studio to rapidly adopt new tools and fit them into their existing pipeline without costly labor, and schedule delays that might not be possible for a given production's delivery date.

To illustrate the problem, we present a greatly simplified example of how the existing textual search-and-replace (method 1) might work in practice. Here are two excerpts from digital content files similar to those created in the “Clarisse” software application developed by the company Isotropix. These files both represent the same asset, which contains embedded references to other files. This example demonstrates how the files, when using the textual search-and-replace, would be edited in order for an artist to work on them without disrupting ongoing activity at the studio.

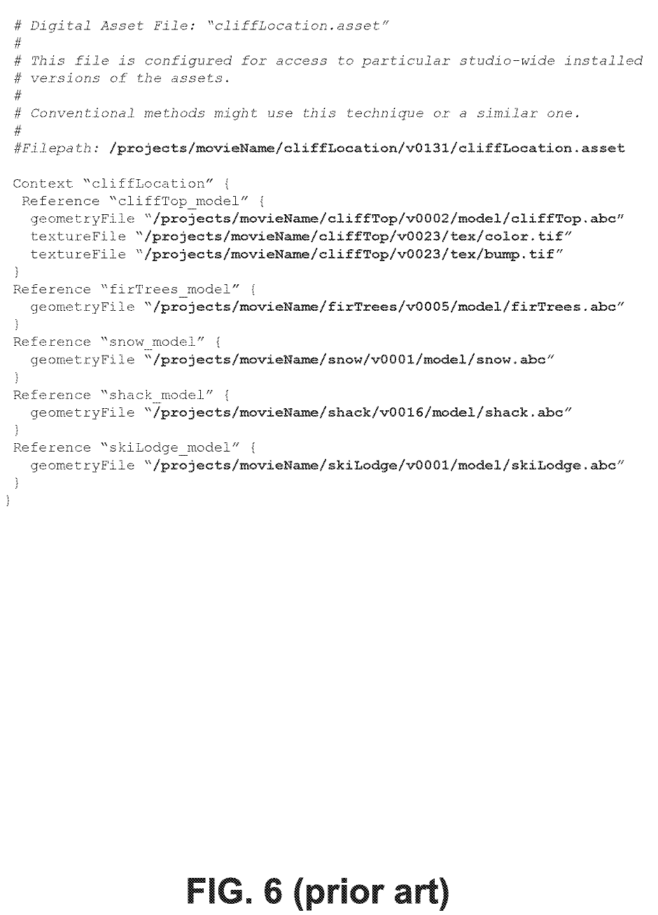

FIG. 6 illustrates an example portion of file that might be used to describe the current version of an asset, as it might appear in a “published” location where members of the studio. The filepaths listed in boldface reference specific locations on the studio's network file system, via what is termed an “absolute path”. In this example, the digital file resides on the filesystem at /projects/movieName/cliffLocation/v0131/cliffLocation.asset.

Within this file, references to external files directly point to specific versions of each file. This is sometimes referred to as having a version “hard wired” inside the file. In this example, such file references are /projects/movieName/cliffTop/v0002/model/cliffTop.abc, /projects/movieName/cliffTop/v0023/tex/color.tif, etc.

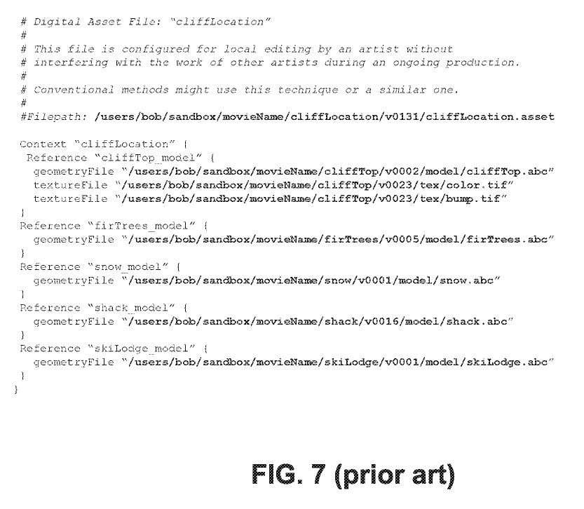

When an artist desires to work on a file like the one exemplified in FIG. 6 above, textual search can be used to translate it into something similar to what is shown in FIG. 7. Notice that in FIG. 7, all the filepaths have been edited to reflect a change in location from their “published” location on the studio-wide network file system to a “sandbox” directory as of the artist named Bob. This method requires that the studio pipeline must be coded to translate all appropriate files when a local “sandbox” copy is made. Since most application software uses different formats for their files, this translation requires a new implementation for every software application the studio uses, and may require updating when the software versions change. It is also not robust, as a textural search-and-replace may have both false positives and false negatives when searching, resulting in an incorrect translation, and/or special code to handle exceptional circumstances.

As noted above, other methods of handling this problem may not use an absolute path, nor explicitly specify the desired version of a referenced file. These methods have different flaws mentioned above; the example we give here is to illustrate the problem in greater specificity.

Virtual Repositories with Flexible Redirection of References

As will be described in more detail, a digital asset management system can create an application transparent abstraction layer for asset authoring, management, and access. This allows for the virtualization of pathnames to any file, including embedded references to other files in the repository.

In one aspect, the digital asset management system uses modifications to an operating system, such as kernel modifications, to allow the digital asset management system to intercept any filesystem operations that reference files on the virtual repository. The digital asset management system then translates path references to digital files from a virtual location to a physical location. The digital asset management system and/or programs that access assets can easily retrieve the correct version of data needed, which is served to the operating system and thence to the application software and user. In some embodiments, the digital asset management system uses a feature available in most modern operating systems called a “filesystem in userspace” that allows for intercepting and redirecting file system requests without direct modification to the operating system itself.

Run-time redirection of filepaths from a virtual or generic filesystem location is possible to a real location of the correct and desired version of the asset. Selection of which physical version of the file should be used can be elided in the reference within the virtual filesystem. Which version of a file is desired can be specified in a manner that is external to the application software and transparent to the application software.

When digital assets contain embedded references to external files, which is frequently necessary with files such as texture images or nested hierarchies of geometry, these references are embedded as a filepath to the desired asset. Since filepaths are usable almost universally throughout vendor and proprietary software, the techniques herein can be easily applied in a variety of situations. They can operate independently of the digital content creation applications being used, with both vendor and proprietary software. It can be transparent to the content creation software, meaning that the application being used can be unaware that the redirection is occurring, instead perceiving that the data exists in the virtual location. This yields the significant advantage that it can be used without modification of that software. This makes it easier to integrate new tools into existing pipelines, and substantially reduces the cost and increases the reliability of such systems.

In another aspect, the digital asset management system provides for an abstraction referred to herein as “views”, which are an agglomeration of selections of specific versions of any file, directory, or set of files and directories. These files can be selected from among files that have been installed for studio-wide access, or be local “sandbox” versions which an artist is editing, or any combination thereof. Views are part of the mechanism which allows the virtual filesystem to supply users with the desired versions of the digital content files.

These views can be created and edited via a command line interface, graphical user interfaces, or algorithmic methods. The creation and editing of views can happen outside any application software. Multiple views can exist concurrently, and the system can resolve an arbitrary number of simultaneous requests for a virtual filepath to the many different physical files, based on which view is appropriate for the given request. Views can be independent of, or shared between, different users, use cases, and departments.

Views can be assigned based on various criteria and at various levels of granularity. This granularity can be extremely coarse, such as for an entire production studio or team. A finer granularity would be exemplified by assigning one view to a particular user. Still finer granularity might include assigning views to specific host or remote computers, or by specific computer process IDs or their descendent processes, or by using environment variables, or via other criteria or the combination of criteria.

One use of a view is to allow a user to interact with one set of physical files that are sandboxed and then by simply switching the view, interact with a production set of those same files, all while referring to the same virtual pathnames. Once a user is done with the sandbox versions of files, the user can “publish” them to the back-end repository and/or alter the view that is used. Views might also be used to prevent subsequent changes from affecting other files unintentionally.

The data structures representing views might each be assigned universal unique IDs and might be allowed to be combined and/or aggregated. Instead of, or in addition to, universal unique ID (“UUID”), views might also be assigned mnemonic nicknames, or other identifiers. A data structure for a view might be set to be read-only, temporarily or permanently.

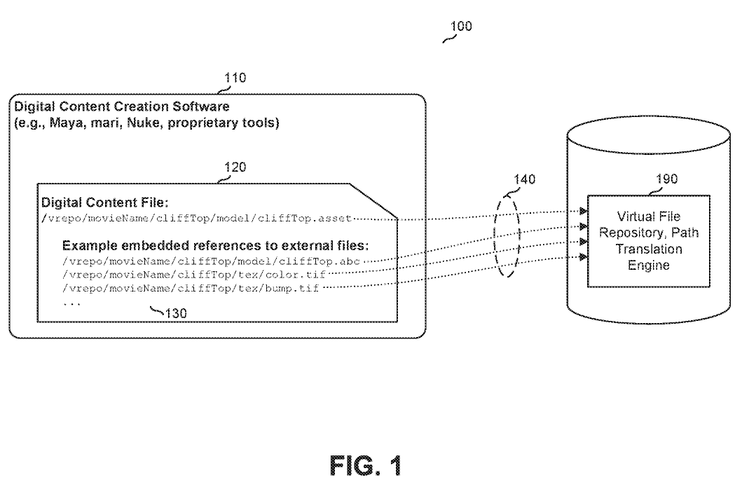

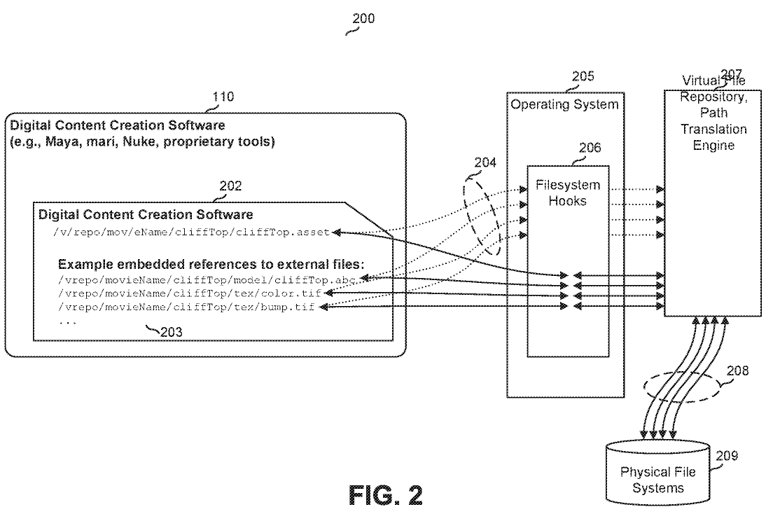

FIG. 1 and FIG. 2 illustrate how the present invention might be implemented on a typical computer system.

FIG. 1 shows how a user, and any application software 110, might perceive the virtual repository. The user might use digital content creation software 110, such as commercially available packages like Maya, Nuke, Mari, etc., or proprietary software that was developed in-house. This software would create a digital asset file 120, located on the virtual filesystem 190. The file 120 contains embedded references to external files 130 that also point to locations on the virtual filesystem.

The locations specified by the file references 140 are drawn in dotted lines, and do not specify the physical location of the desired file. Instead, they refer to a generic or virtual location that will be resolved by a virtual repository path translation engine 190. Since the filepaths 130 do not explicitly mandate specific versions of the referenced asset, they thereby allow the system to defer resolving the desired version of the asset until run time.

FIG. 2 shows a more detailed view of a digital asset management system 200 and its operation. An asset 202 might contain file system references 203. Filesystem references 203 in file system calls 204 are redirected by an operating system 205 to the digital asset management system via hooks 206 that are called whenever the operating system is asked to make a filesystem operation. If the file is part of the virtual repository, the path translation engine 207 converts the virtual paths to physical paths 208 on an actual network or local filesystem 209. These hooks 206 can be implemented using modifications to the operating system's kernel, utilizing common features like a “filesystem in userspace” feature or other methods.

Any time the digital content creation software 110 needs to access a reference to an embedded asset 203, such as texture map, geometry file, or a reference to another component of the asset 202, it makes a file system call 204 to the operating system 205.

When calling the operating system 205 to read or write any file on the virtual repository, the operating system hooks 206 will intercept that call, and redirect it to the virtual repository path translation engine 207. The virtual repository path translation engine 207 will translate the virtual file system paths 203 to physical file system paths, residing on a physical filesystem 209.

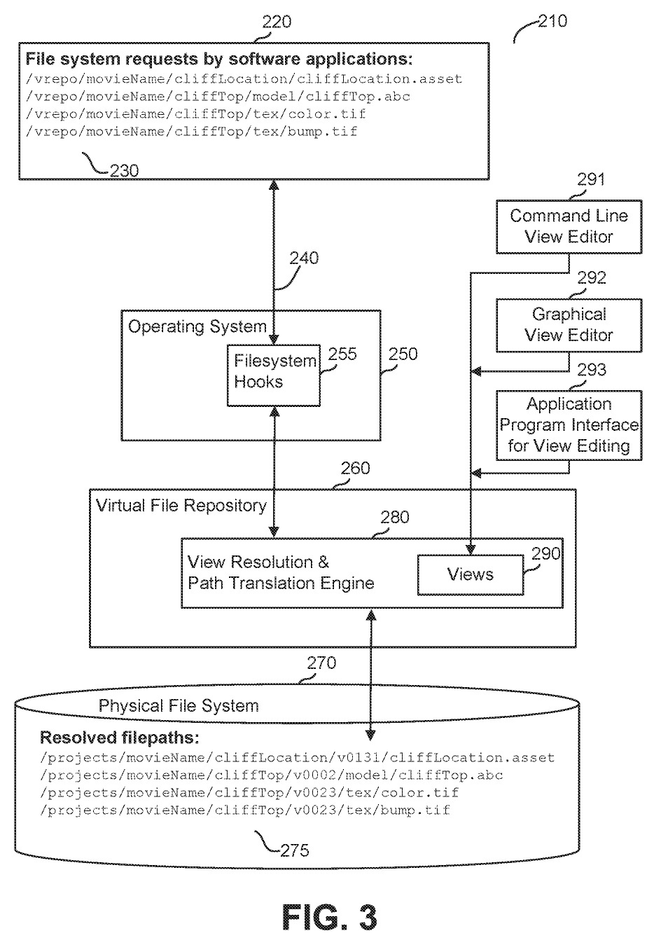

FIG. 3 is a simplified schematic drawing of intercepting access to files on the virtual repository. It shows portions of a digital asset management system 210 and how that might intercept file access requests (e.g., read, write, or metadata) that are on a virtual repository 260, resolve them to the correct physical version of the file, and return data from the correct file and/or write data to the correct file.

Application software 220 will request some number of files 230 which they need to access. These file access requests 240 are sent to the operating system 250. Filesystem hooks 255 that are part of the operating system 250 will intercept filesystem operations, and route them through the path translation component 280 that performs view resolution and path translation. That will resolve any references to the virtual file repository 260 to the appropriate location on the physical file system 270.

The path translation component 280 may retrieve a view, which encapsulates a mapping between virtual paths and physical filepaths, including such metadata as the creator of the view, the production or sequence it is used for, the particular use case it applies to, and/or whether and who it can be shared with. View resolution, a process of converting from a virtual file pathname to a physical file pathname, can be done in a number of ways, as explained herein.

Views 290 can be specified directly by the user, through a graphical user interface 292, command line interface 291, or algorithmically via an application programmer interface 293. Using the information from the selected view, the path translation component 280 will compute the correct resolved filepaths 275 and retrieve the appropriate data from the physical filesystem 270. This data will then be served back to the operating system 250 and application software 220.

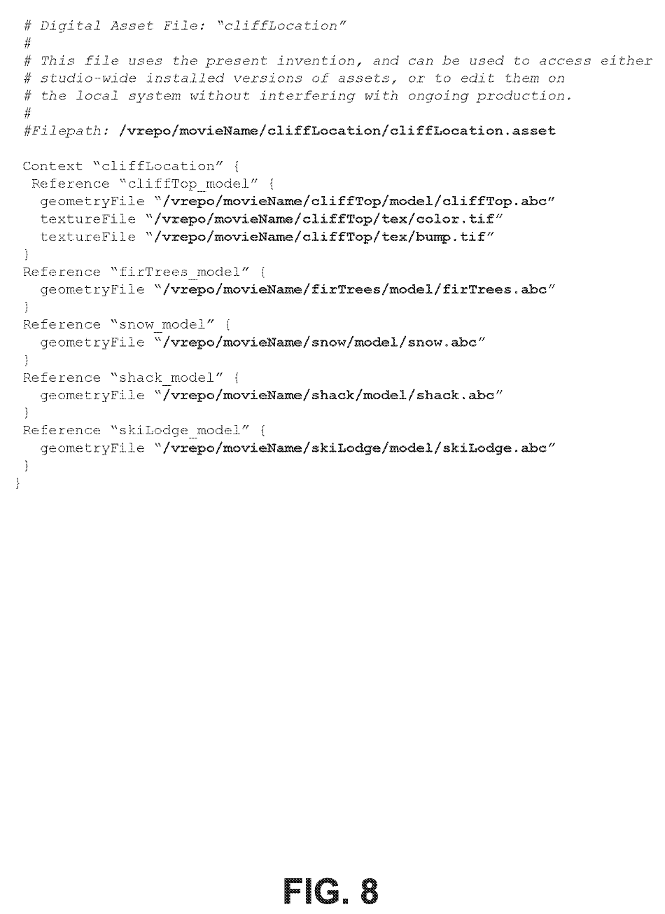

To further demonstrate an advantage of the digital asset management system, consider the example given in FIG. 6 and FIG. 7 that illustrate limitations of current approaches. In contrast with the novel digital asset management system illustrated in FIG. 8, the pathname of the digital asset file, and the pathnames of any externally referenced files that are embedded with it, are the same in all cases. Note that the pathnames in FIG. 8 do not require inclusion of any of the version information specified in the prior approach shown in FIG. 6, nor do they explicitly specify a path to a “sandbox” location as in the prior approach shown in FIG. 7. With the novel system, users can access multiple versions of constituent files without having to explicitly alter filepaths, whether those filepaths are directly accessed by the user, or embedded within other files.

Since versions or physical locations do not have to be specified explicitly, this allows for “version elision,” the ability to remove (i.e., “elide”) the revision number from the pathname to an asset. A digital asset management system provides version elision by using a specific “view,” set of views, or hierarchy of views to resolve the mapping from the virtual location to a physical location on the repository. This defines how the file paths within the virtual file system can be dynamically resolved at run-time.

Under version elision, an embedded file referenced need not be specified (aka “hardcoded” or “baked into”) inside the referencing file. Instead, the referenced item is specified as a “generic” location on the virtual repository. A software application will ask for the “generic” location in the virtual repository, and the system will use the appropriate view to resolve the generic location to the appropriate physical location. It will then serve the resolved file to the application.

Another aspect is the use of dynamic views, wherein a view data structure can be changed dynamically, even while some of the files are in use. When views are changed dynamically, that may change the mappings of virtual file pathnames to physical file pathnames. A change of a view can be reported to existing software applications that are using that view, so that they can reload files from the virtual file system as needed. Since a sudden change of the view (and hence the file mapping) could potentially cause file corruption, view changes that would interfere with an existing computer process can be intercepted. For example, certain software applications may rely on files to not change during the process of reading or writing. The digital asset management system can use its knowledge of which files are currently being accessed to detect a view request change that would cause such problems. The system can then take appropriate action, such as notifying the user, and/or postponing the change, and/or sending interprocess communication messages to software applications to notify them of the change, and allow them to reload files from the virtual file system. This can avoid the crash of a software application to which prior art methods would be vulnerable.

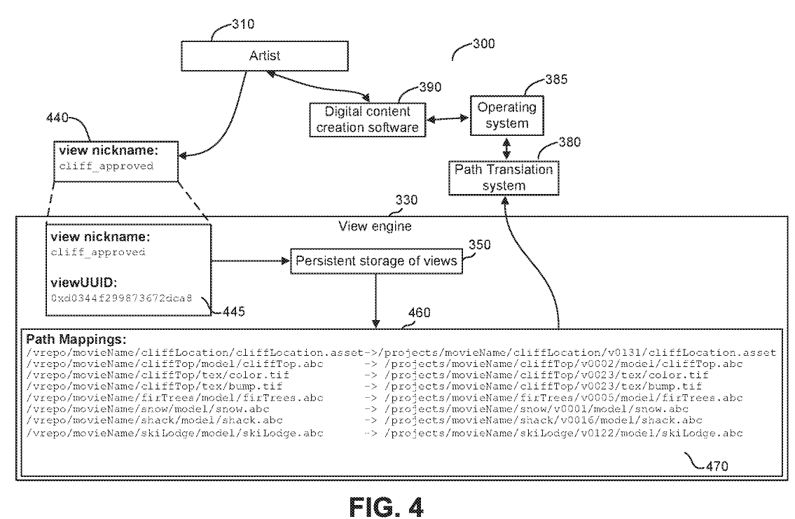

FIG. 4 shows a simplified schematic diagram of how artists can select and use different views. An artist, using a digital asset management system 300, might select and use a specific view to access relevant content for their current task. For example, the artist might desire to access specific versions of files as they are installed on a studio-wide repository. In that case, the artist needs to access a set of specific versions of the various constituent files in an asset, as was intended by the listing shown in FIG. 6. Here, we will show how the present invention accomplishes the same goal as intended in that use case.

The artist 310 creates or selects a view which has the appropriate versions for their task. View creation can be done through such methods as a command line interface, a graphical user interface, via an automated or algorithmic method, or some other manner. These view selections are communicated to the view engine 330, which resolves any symbolic nickname 340 and retrieves the correct view data 360 from the view storage system 350. The interface used for view creation can also be used for editing a view dataset.

This view data 360 includes path mappings 370, which will translate the paths from the virtual locations listed in FIG. 8 to the physical locations that were desired by the artist. This data are sent to the path translation system 380 and operating system 385, as previously detailed, which then supplies it to digital content creation software 390.

Note that the system does not restrict resolution of a path translation to a one-to-one mapping of virtual files to physical files. Since any asset that is the target of a remapping may include a different set of embedded assets, the topology of directed acyclic graph (DAG) that comprises the asset may be different from one view to another.

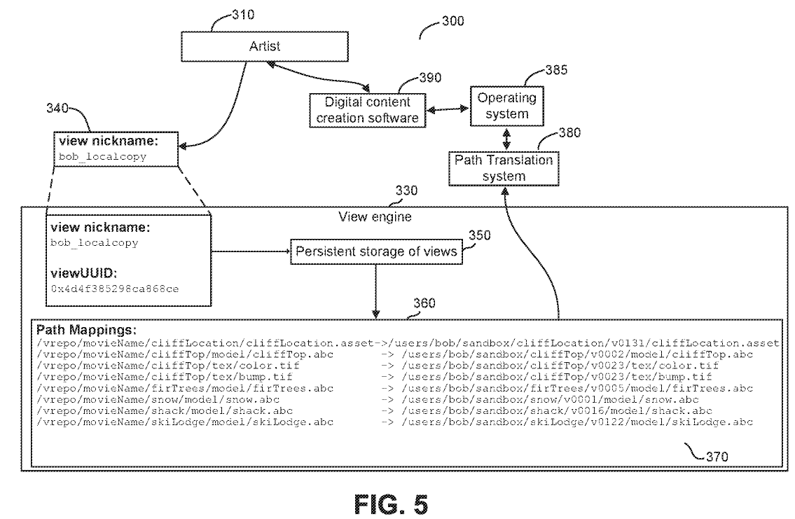

To accomplish the use case as specified in FIG. 7, we would use different view data 460, as depicted in FIG. 5. All of the components of FIG. 5 can be the same as their counterparts in FIG. 4, except the artist selects a different view 440. This view has a different UUID 445 and different path mappings 470. FIG. 5 shows how an artist, using the digital asset management system, could access a local “sandbox” copy of the asset's files, such that he could edit them without disturbing existing work until he is ready to install.

When using the transparent path translation aspects, the identical asset file in FIG. 8 can be used for the case where the artist needs to access the installed files on the studio-wide repository as in FIG. 6, and also when editing files in their local sandbox as in FIG. 7.

Note that, as detailed in FIG. 8, the identical asset file can be used in multiple use cases and contexts. This exemplifies what we refer to as version elision. Since this can be done via transparent path translation, it can be easily applied with little or no modification to existing vendor or proprietary software.

Prior methods of transparent path translation exist, but they are not suitable for the needs of many digital content creation projects. The digital asset management system described herein provides fine grained control over path translation, such that any system process can simultaneously have its own view of the file system. This allows many artists to work simultaneously, with each of them able to use different combinations of particular asset revisions. Finer granularity yet can be achieved, as each artist can use multiple different views, if working on several assets with different requirements. And yet finer granularity is possible, as views can be attached to any single process or thread of execution on a computer.

For example, network file systems can be considered a form of providing transparent path translation, but these systems do not allow for the level of fine grained control that the digital asset management system described here provides. Load balancing systems and file caching systems provide a finer granularity of path translation, but are not designed to solve the problem at hand; they are designed to optimize speed and latency of access to files, without allowing a choice between various versions of the same file. The digital asset management system described here allows user and/or algorithmic control over the targets of the path translation. Virtual machines or containerization techniques are more intrusive to the users, and do not integrate as seamlessly with existing production pipelines.

When the artist finishes with their local “sandbox” modifications, they can publish them so that the rest of the studio can use their modifications. Sandboxing is a way to provide an artist to be able to access and edit certain files such that they do not interfere or interact with a wider set of files. Once an artist or other editor is done with a set of assets, they can “publish” them by indicating to the digital asset management system that the assets should be available to a wider array of users. The digital asset management system is able to handle publication without requiring any modification of the paths to any file, or any embedded pathname references to external files.

While the previous usages of search paths have some advantages, the digital asset management system described here provides additional advantages. For example, a search path system resolves references in a file that contains references by searching through a series of specified directories. This is a usable system only in cases where a studio programs either all or the vast majority of their own software, since that software will need to recognize and implement the searching in a consistent manner. Otherwise, different accommodations need to be made for software that the studio cannot modify. The digital asset management system has no such drawback, and can work with vendor software and proprietary software alike. It does not require customization or enhancement of the software, either by “wrapper scripts” or “plug-ins”. Since it functions in a manner that is transparent to the content creation software, it provides a simpler, more reliable, and less labor intensive way to integrate usage of various software packages.

### Variations

In another embodiment, users can access files on the virtual file system directly. Like the manner in which embedded pathnames can be resolved, the file that the user opens directly in their digital content creation software (for example, via a “File Open . . . ” dialog) can be referenced through a virtual filepath, and be resolved in the same manner.

In another embodiment, it is not limited to use by digital content creation software. The virtual file system allows the user to interact with it using the same tools and interfaces that they already do with a “standard” filesystem. For example, they can use the same command-line “shell,” or graphical user interface tools that they already use. Views can be selected so that the appropriate and desired file resolution occurs via this mode of access. A conventional operating system file access application, such as a filesystem browser might be used to locate files and with the digital asset management system, even direct specification of pathnames can be virtualized for the users of the operating system file access application.

### Implementation Details

As has been described above, a digital asset management system provides for storing, reading, writing, accessing, publishing, and controlling access to, digital assets where the users and the software that performs those actions for the users resolves locations on physical storage using a virtual file system that is transparent to that software. Application software that requests access to files using pathnames on the virtual file system makes operating system requests using those pathnames. The operating system is instructed (using hooks, or otherwise) to forward file requests to the translation engine that handles file accesses. A virtual repository path translation engine receives the file access requests, translating them from a virtual file system location to a physical path where the file actually resides. The operating system then provides the contents of the file to the application software that originally made the request. Thus, any software application that makes a file system request will perceive the virtual file system to be indistinguishable from its normal methods of accessing such files on a physical or network filesystem, except perhaps some miniscule variation in access times.

The path resolution engine might alter the translation based on a “view” data structure that creates different “views” of the same virtual file system pathname by returning different physical paths in different contexts. This facilitates version elision, by which the appropriate version of a referenced file need not be explicit inside the referencing file. Instead, the referenced item is specified as a generic location on the virtual repository. A software application will ask for the generic location in the virtual repository, and the digital asset management system will use the appropriate view to resolve the generic location to the appropriate physical location. It will then serve the resolved file to the application.

The virtual filesystem need not be referencing the same filesystem where the physical files are located. This allows for the files to be transparently distributed.

Different views of a filesystem can be created, by encapsulation. Artists at the studio can select particular iterations, variations, or revisions of files and then create a view of them, such that the selected files work together appropriately. The artist's selections are recorded in a view dataset that encapsulates the mapping, translation, and resolution of virtual file paths to physical file paths. This provides a mechanism to encapsulate and record the knowledge and decisions of technicians and artists. These views data structures can be saved in a persistent manner, for example in a relational database, key value store, or a serialized data file such as a JSON file or an XML file. Users are thereby able to persistently access such views, and share them with other users.

In some variations, instead of a file access being transparently transformed, a user or software program can make a request of the digital asset management system to return the physical pathname of the file. In effect, the digital asset management system will “resolve” a virtual filesystem pathname to a physical filesystem pathname and return the physical filesystem pathname in response to a query that contained the virtual filesystem pathname, rather than reading, writing the file's data or metadata itself.

It is also possible for users to perform standard filesystem operations on the virtual filesystem, in the same manner they would be able to on a physical filesystem, such as through a command line shell or an interactive file browser. Such operations include, but are not limited to, read, write, rename, delete, retrieving file size and modification time.

More generally, an application or a user initiates a file access request, which might be one or more of a write request, a read request, a metadata request, a modify request, a delete request, a create request, an open request, and/or a close request. The digital asset management system intercepts this request transparent to the requestor, and resolves a file pathname in the request from a virtual pathname to a physical pathname determined by the digital asset management system. The digital asset management system does this using a mapping that it has between virtual pathnames and physical pathnames. The mapping might be specified in a view dataset, where making one view dataset active over other view datasets could alter the mapping of many files as a group.

A dataset is a data structure that can be read by various computer components to obtain data about the view structure and the dataset can also be modified by various computer components. A view dataset might correspond to one or more of a specific iteration, variation, or revision of one or more files or assets. Virtual pathnames and physical pathnames need not have a one-to-one correspondence, such that one virtual pathname can resolve to more than one physical pathname. The particular physical pathname that a given virtual pathname resolves to is determined from the view dataset currently in use.

The digital asset management system might also include methods for automatic deduplication of files that are identical, to optimize the utilization of storage space or other limited computer resources. The digital asset management system might also include methods that can inform the user of the status of a file, with respect to the current installed version, any other version that has been previously checked in, or any other versions that other users are working with.

Some methods might allow for logging of which set of digital asset files are used to perform particular tasks, including but not limited to the constituent elements used to “render” a particular image. This logging can be used for debugging renders, optimizing system and network performance, and allowing artists to be able to quickly and reliably find which versions went into a specific render.

During the course of production, files might be shared from one user to another, often without going through a version control system. The digital asset management system might allow for tracking of what file formed the basis for a current file, and which users made changes, and when.

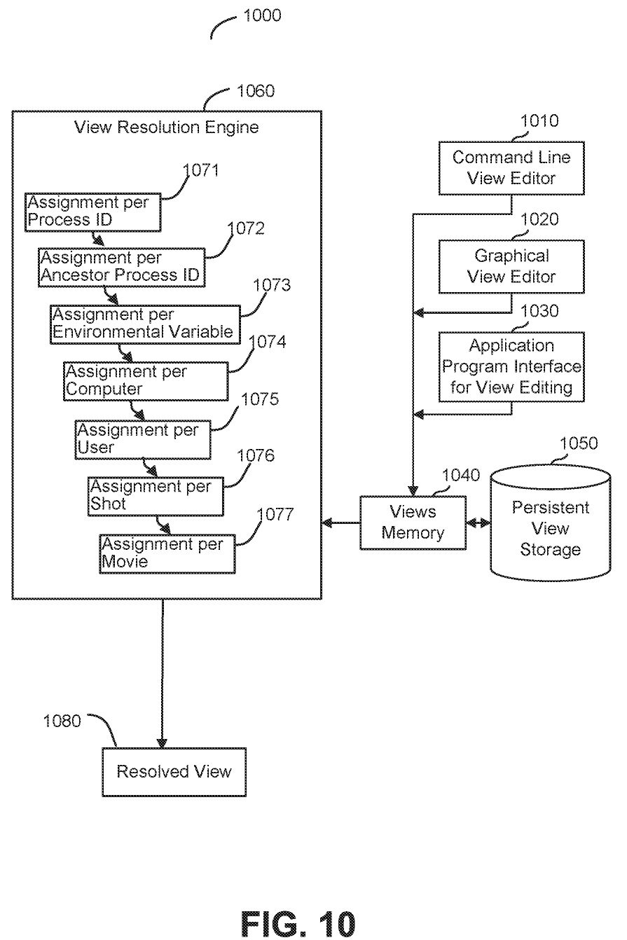

FIG. 10 illustrates aspects of a view resolution engine system 1000. As shown there, a command line editor 1010, a graphical view dataset editor 1020, and/or an application programming interface (API) 1030 are provided for editing a view dataset or creating one to define a view. The view dataset being edited can be stored in a working memory 1040 while being edited and multiple view datasets might be stored in persistent view storage 1050. Persistent view storage 1050 might be a data file, a relational database, or a key-value store, or other structure.

Different view datasets might reference the same virtual files and/or the same physical files. Those different view datasets might be used at the same time, by different users. For example, two users might be operating their respective instances of a computer animation system and open the same file or two files that have embedded links to the same set of virtual files. However, by using different views, each user could be actually operating on or with different physical files, or some different files and some of the same files. Similarly, the two users might be requesting two differently named virtual pathnames, but their different view datasets might map those two differently named virtual pathnames to the same physical file name. More than two view datasets can be used simultaneously and might be selected based on criteria that is different from user to user. This would allow for different mappings for different users, and this as well might be dynamic in that one or more of the users' view dataset would change and thus their mappings would change while in use. In some instances, one user's overall “view” of files available to that user might be determined by a combination of multiple view datasets. The combination might be the union of two or more view datasets, a combination wherein one view dataset is given a higher priority in case of conflicts, a merger, or some other combination.

A view resolution engine 1060 itself reads a view dataset and resolves that view into a resolved view dataset 1080, which may itself resolve to a physical file pathname or a view. View resolution engine 1060 includes a first process 1071 for assigning details of a file reference based on a process identifier (ID), a second process 1072 for assigning details of a file reference based on an parent or ancestor process ID, a third process 1073 for assigning details of a file reference based on an environment variable that are set in the computational task's operating context, a fourth process 1074 for assigning details of a file reference based on a computer ID, a fifth process 1075 for assigning details of a file reference based on a user ID, a sixth process 1076 for assigning details of a file reference based on a shot ID, and a seventh process 1077 for assigning details of a file reference based on a movie or feature ID. Other bases might be included as well. Views can be assigned based on various criteria and at various levels of granularity using those processes, and other processes, such as a process that determines how to assign details of a file reference based on the availability, or lack thereof, of computer resources, such as memory, available licenses, time of day, date, or other criteria or combination of criteria.

Using one or more, or all, of these identifiers and/or variables, view resolution engine 1060 resolves and generates file references, such as physical pathnames, or indirect references for a view dataset. As previously explained, views can be assigned based on various criteria and at various levels of granularity, such as for an entire production studio or team or down to assigning views to specific host or remote computers. A repository may be simultaneously using different views for any given file request. View resolution engine 1060 can use any number of criteria to determine the correct view to use for any given file request.

In some embodiments, the view resolution processes are sequential in a “waterfall” so that a lower process only resolves when a higher process has not already resolved a view. For example, if the first process determines which view to use based on process ID, the second through seventh processes might be skipped. If the process ID has no particular view associated with it, or if the specification of its view describes only part of the view assignment and leaves other parts undefined, view resolution can proceed using lower processes (second to seventh, in this example) to examine other criteria to fully define the resolved view.

At any given layer of granularity, various inheritance operations can be used to determine either the entirety of a view, or allow parts of the view to be defined at other layers. Note that the order of resolution contained in this diagram is exemplary only. Other priority orders, such as those that prioritize an environment variable ahead of a process ID, can be used. Resolution may in some cases proceed in the reverse order to the one described, where coarser granularities are queried first and combined with finer granularities as may be desired. These procedures together select or derive the final, resolved view 1080 that the virtual file system can use to map filesystem operations from virtual paths to physical paths.

According to one embodiment, the techniques described herein are implemented by one or generalized computing systems programmed to perform the techniques pursuant to program instructions in firmware, memory, other storage, or a combination. Special-purpose computing devices may be used, such as desktop computer systems, portable computer systems, handheld devices, networking devices or any other device that incorporates hard-wired and/or program logic to implement the techniques.

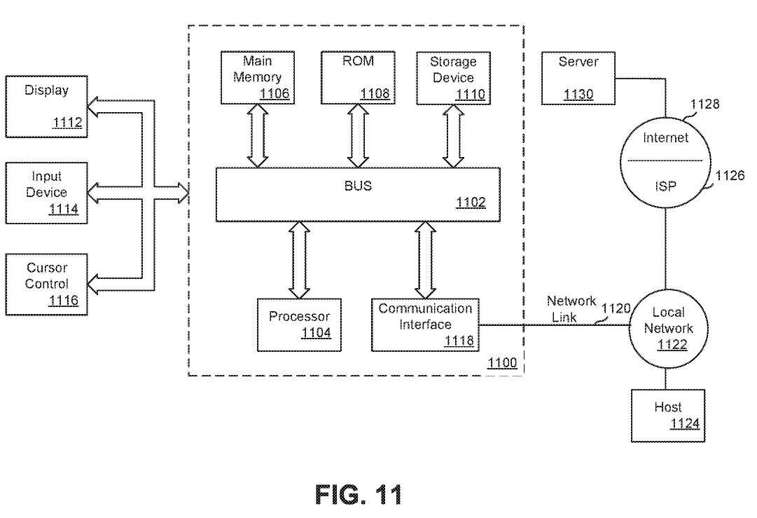

For example, FIG. 11 is a block diagram that illustrates a computer system 1100 upon which an embodiment of the invention may be implemented. Computer system 1100 includes a bus 1102 or other communication mechanism for communicating information, and a processor 1104 coupled with bus 1102 for processing information. Processor 1104 may be, for example, a general purpose microprocessor.

Computer system 1100 also includes a main memory 1106, such as a random access memory (RAM) or other dynamic storage device, coupled to bus 1102 for storing information and instructions to be executed by processor 1104. Main memory 1106 also may be used for storing temporary variables or other intermediate information during execution of instructions to be executed by processor 1104. Such instructions, when stored in non-transitory storage media accessible to processor 1104, render computer system 1100 into a special-purpose machine that is customized to perform the operations specified in the instructions.

Computer system 1100 further includes a read only memory (ROM) 1108 or other static storage device coupled to bus 1102 for storing static information and instructions for processor 1104. A storage device 1110, such as a magnetic disk or optical disk, is provided and coupled to bus 1102 for storing information and instructions.

Computer system 1100 may be coupled via bus 1102 to a display 1112, such as a computer monitor, for displaying information to a computer user. An input device 1114, including alphanumeric and other keys, is coupled to bus 1102 for communicating information and command selections to processor 1104. Another type of user input device is cursor control 1116, such as a mouse, a trackball, or cursor direction keys for communicating direction information and command selections to processor 1104 and for controlling cursor movement on display 1112. This input device typically has two degrees of freedom in two axes, a first axis (e.g., x) and a second axis (e.g., y), that allows the device to specify positions in a plane.

Computer system 1100 may implement the techniques described herein using customized hard-wired logic, one or more ASICs or FPGAs, firmware and/or program logic which in combination with the computer system causes or programs computer system 1100 to be a special-purpose machine. According to one embodiment, the techniques herein are performed by computer system 1100 in response to processor 1104 executing one or more sequences of one or more instructions contained in main memory 1106. Such instructions may be read into main memory 1106 from another storage medium, such as storage device 1110. Execution of the sequences of instructions contained in main memory 1106 causes processor 1104 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device 1110. Volatile media includes dynamic memory, such as main memory 1106. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, an EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 1102. Transmission media can also take the form of acoustic or light waves, such as those generated during radio-wave and infra-red data communications.

Various forms of media may be involved in carrying one or more sequences of one or more instructions to processor 1104 for execution. For example, the instructions may initially be carried on a magnetic disk or solid state drive of a remote computer. The remote computer can load the instructions into its dynamic memory and send the instructions over a network connection. A modem or network interface local to computer system 1100 can receive the data. Bus 1102 carries the data to main memory 1106, from which processor 1104 retrieves and executes the instructions. The instructions received by main memory 1106 may optionally be stored on storage device 1110 either before or after execution by processor 1104.

Computer system 1100 also includes a communication interface 1118 coupled to bus 1102. Communication interface 1118 provides a two-way data communication coupling to a network link 1120 that is connected to a local network 1122. For example, communication interface 1118 may be an integrated services digital network (ISDN) card, cable modem, satellite modem, or a modem to provide a data communication connection to a corresponding type of telephone line. Wireless links may also be implemented. In any such implementation, communication interface 1118 sends and receives electrical, electromagnetic or optical signals that carry digital data streams representing various types of information.

Network link 1120 typically provides data communication through one or more networks to other data devices. For example, network link 1120 may provide a connection through local network 1122 to a host computer 1124 or to data equipment operated by an Internet Service Provider (ISP) 1126. ISP 1126 in turn provides data communication services through the world wide packet data communication network now commonly referred to as the “Internet” 1128. Local network 1122 and Internet 1128 both use electrical, electromagnetic or optical signals that carry digital data streams. The signals through the various networks and the signals on network link 1120 and through communication interface 1118, which carry the digital data to and from computer system 1100, are example forms of transmission media.

Computer system 1100 can send messages and receive data, including program code, through the network(s), network link 1120 and communication interface 1118. In the Internet example, a server 1130 might transmit a requested code for an application program through Internet 1128, ISP 1126, local network 1122 and communication interface 1118. The received code may be executed by processor 1104 as it is received, and/or stored in storage device 1110, or other non-volatile storage for later execution.

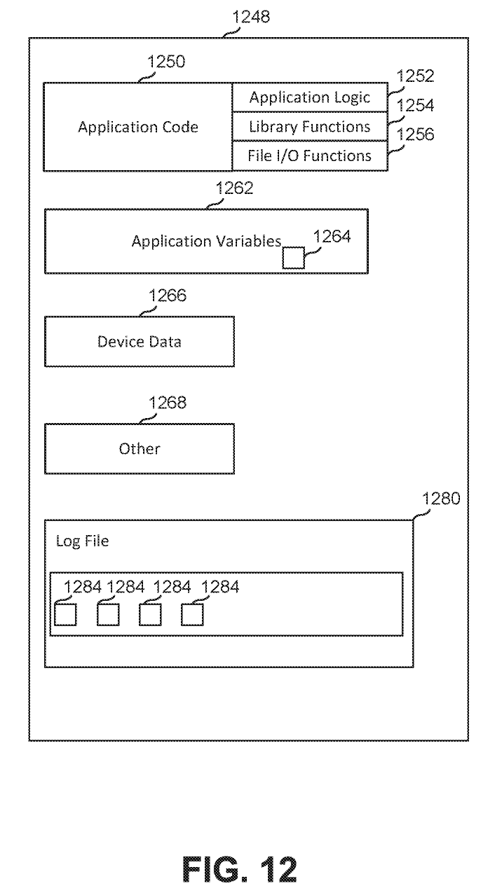

FIG. 12 is a simplified functional block diagram of a storage device 1248 having an application that can be accessed and executed by a processor in a computer system. The application can one or more of the applications described herein, running on servers, clients or other platforms or devices. Storage device 1248 can be one or more memory devices that can be accessed by a processor and storage device 1248 can have stored thereon application code 1250 that can be configured to store one or more processor readable instructions. The application code 1250 can include application logic 1252, library functions 1254, and file I/O functions 1256 associated with the application.

Storage device 1248 can also include application variables 1262 that can include one or more storage locations configured to receive input variables 1264. The application variables 1262 can include variables that are generated by the application or otherwise local to the application. The application variables 1262 can be generated, for example, from data retrieved from an external source, such as a user or an external device or application. The processor can execute the application code 1250 to generate the application variables 1262 provided to storage device 1248.

One or more memory locations can be configured to store device data 1266. Device data 1266 can include data that is sourced by an external source, such as a user or an external device. Device data 1266 can include, for example, records being passed between servers prior to being transmitted or after being received.

Storage device 1248 can also include a log file 1280 having one or more storage locations 1284 configured to store results of the application or inputs provided to the application. For example, the log file 1280 can be configured to store a history of actions.

Operations of processes described herein can be performed in any suitable order unless otherwise indicated herein or otherwise clearly contradicted by context. Processes described herein (or variations and/or combinations thereof) may be performed under the control of one or more computer systems configured with executable instructions and may be implemented as code (e.g., executable instructions, one or more computer programs or one or more applications) executing collectively on one or more processors, by hardware or combinations thereof. The code may be stored on a computer-readable storage medium, for example, in the form of a computer program comprising a plurality of instructions executable by one or more processors. The computer-readable storage medium may be non-transitory.

Conjunctive language, such as phrases of the form “at least one of A, B, and C,” or “at least one of A, B and C,” unless specifically stated otherwise or otherwise clearly contradicted by context, is otherwise understood with the context as used in general to present that an item, term, etc., may be either A or B or C, or any nonempty subset of the set of A and B and C. For instance, in the illustrative example of a set having three members, the conjunctive phrases “at least one of A, B, and C” and “at least one of A, B and C” refer to any of the following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present.

The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

Further embodiments can be envisioned to one of ordinary skill in the art after reading this disclosure. In other embodiments, combinations or sub-combinations of the above-disclosed invention can be advantageously made. The example arrangements of components are shown for purposes of illustration and it should be understood that combinations, additions, re-arrangements, and the like are contemplated in alternative embodiments of the present invention. Thus, while the invention has been described with respect to exemplary embodiments, one skilled in the art will recognize that numerous modifications are possible.

For example, the processes described herein may be implemented using hardware components, software components, and/or any combination thereof. The specification and drawings are, accordingly, to be regarded in an illustrative rather than a restrictive sense. It will, however, be evident that various modifications and changes may be made thereunto without departing from the broader spirit and scope of the invention as set forth in the claims and that the invention is intended to cover all modifications and equivalents within the scope of the following claims.

All references, including publications, patent applications, and patents, cited herein are hereby incorporated by reference to the same extent as if each reference were individually and specifically indicated to be incorporated by reference and were set forth in its entirety herein.

What is claimed is:

1. A system, comprising:
at least one computing device configured to implement one or more services, wherein the one or more services are configured to:
perform path translations, wherein files are referenced using virtual file system pathnames and a path translation translates a virtual file system pathname to a physical file system pathname;
intercept an original file access request from an application, wherein the original file access request is directed to an operating system;
resolve a file pathname in the original file access request from a virtual pathname to a physical pathname;
pass a modified file access request to the operating system, wherein the modified file access request corresponds to the original file access request with the physical pathname in place of the virtual pathname;
receive a response from the operating system, the response being to the modified file access request; and
pass the response to the application that made the original file access request.

2. The system of claim 1, wherein the original file access request was one or more of a write request, a read request, a metadata request, a modify request, a delete request, a create request, an open request, and/or a close request.

3. The system of claim 1, wherein the virtual pathname originated as an embedded reference in a referencing file and wherein the referencing file is a file that contains references to other files.

4. The system of claim 1, wherein the application is a file access application that receives from a user the virtual file system pathname and executes the modified file access request.

5. The system of claim 4, wherein the file access application comprises one or more of a command line shell or an interactive file browser.

6. The system of claim 1, wherein resolving the file pathname in the original file access request from a virtual pathname to a physical pathname based on a view dataset previously selected from among a plurality of view datasets.

7. The system of claim 6, wherein virtual pathnames and physical pathnames are not required to have a one-to-one correspondence, such that one virtual pathname can resolve to more than one physical pathname, and wherein a particular physical pathname that a virtual pathname resolves to is determined from the view dataset.

8. The system of claim 7, wherein the particular physical pathname is a particular version of a file and the view dataset includes data indicating which version of the file is to be used when the view dataset is active.

9. The system of claim 6, wherein a view dataset corresponds to one or more of a specific iteration, variation, or revision of one or more files.

10. The system of claim 9, further comprising persistent storage for view datasets comprising one or more of a relational database, a key value store, a serialized data file, a JSON file, and/or an XML, file.

11. The system of claim 9, further comprising a view dataset editor for editing a view dataset.

12. The system of claim 11, wherein the view dataset editor comprises one or more of a graphical user interfaces, an application programmer interface (API), a command line interface, or a program that edits based on programmatic control.

13. The system of claim 6, further comprising an interface for editing the view dataset and an engine for resolving physical file pathnames based on a series of processes that sequentially resolve a virtual pathname into a physical pathname wherein subsequent processes are skipped once a process of the series of processes full resolves the physical pathname.

14. The system of claim 6, wherein the view dataset used for a particular operation is selected based on predetermined criteria corresponding to a user for that particular operation.

15. The system of claim 6, further comprising logic for managing multiple view datasets such that different users can use different view datasets for the same virtual file pathnames and/or the same physical file pathnames.

16. The system of claim 6, further comprising logic for managing multiple view datasets such that a user can use a combination of more than one view dataset at a time.
